(19) United States
(12) Patent Application Publication
(10) Pub. No.: US 2018/0197031 A1
(43) Pub. Date: Jul. 12, 2018

(54) PHYSICAL MARKER CODING FOR RESOURCE DISTRIBUTION ADJUSTMENT

(71) Applicant: BANK OF AMERICA CORPORATION, Charlotte, NC (US)

(72) Inventors: Manu Jacob Kurian, Dallas, TX (US); Joseph Benjamin Castinado, North Glenn, CO (US)

(21) Appl. No.: 15/404,340

(22) Filed: Jan. 12, 2017

(51) Int. Cl. G06K 9/00; G08B 25/00; G06Q 20/40; G06Q 20/04

(52) U.S. Cl. CPC G06K 9/00892; G08B 25/009; G06K 9/00167; G06K 9/00181; G06K 2009/00966; G06Q 20/40145; G06Q 20/042; G06K 2009/00939; G06K 9/00442

(57) ABSTRACT

Embodiments of the invention are directed to systems, methods and computer program products for providing physical marker coding for resource distribution adjustment or duress signaling when using paper resource distribution documents. Paper resource distribution documents have limited amount of multi-factor authentication. Thus, the system provides a system for multi-factor authentication of paper documents for enhancement of the authentication and security of utilizing paper resource distribution documents. Real-time and/or archived bio-data and geo-data are leveraged to validate the authentication of a resource distribution document. The data associated with the resource distribution document presented at a downstream point are used to verify the authentication of the drafting and executing of the resource distribution document.

### BACKGROUND

With advancements in technology, user resource access and distribution without authorization is becoming easier. As such, third parties may be able to manipulate resource access, deposits, and distribution. Furthermore, paper resource distribution documents have limited amounts of multi-factor authentication.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Paper resource distribution documents have limited amount of multi-factor authentication. Thus, a need exists for a physical marker coding for resource distribution adjustment or duress signaling when using paper resource distribution documents. The invention provides multiple opportunities using the system networks described herein to enhance the authentication and security measures for multi-factor paper resource distribution document authentication.

Real-time and/or archived bio-data and geo-data are leveraged to validate the authentication of a resource distribution document presented for deposit. The data associated with the resource distribution document presented at a downstream transaction point can be used to verify that the user was not under duress when drafting and executing the resource distribution document.

The system may stop or flag resource distribution documents, such as checks, that are made under duress. In this way, the system may recognize forced payments and distinguish those from consent payments using multi-factor authentication via geo-data and bio-data. In this way, the system may identify finger orientation, physical marker on a check hotspot, clip/crack location on check, other physical marker on a check, or bio-data such as pressure used to write the check, heart rate, location, time of day, signature style, check profile rules, or the like as marker codes for authentication of the resource distribution document. The system may alert a financial institution or other recipient of the resource distribution document that the document was forced or misappropriated under duress via a silent alert system.

In some embodiments, the time of day, geo-location, heart rate of the user, pressure of the signature on the resource distribution document, and/or signature style on the resource distribution document provide additional data points for processing technology. In some embodiments, QR codes or other physical sensors may be positioned on the resource distribution document such that each check is tied into the sensor reading that is picked up after the check is removed from the checkbook. The signal from the sensor is sent via internet connection, such as from a beacon, wireless internet connection, or the like.

For example, a first user may sign a check at home. The geo-data from the first user's internet-of-things devices, beacons, wireless internet, or the like is captured and now associated with that check at that point of time. The data is uploaded at various data points during the drafting of the check, thus creating a natural data capture that does not involve additional components to the actual check. The first user may hand-off the check to a second user. During the hand-off, the system captures bio-data and geo-data associated with the hand-off. This data is used to validate that the first user did indeed willingly pass the check to the second user. Finally, upon the second user depositing the check, all of the previous bio-data and geo-data may be combined in order to authentication and validate the check for processing.

In another example, there may be a physical sensor associated with the check. In this way, resource distribution document or resource distribution document set of documents may have a physical sensor associated with the document or set of documents. Physical sensors may include QR codes, hot spot location where if marked or pressed by the user indicates duress, a clip/crack location, where if broken indicates duress, and or a physical marker associated with a group of resource distribution documents that indicate an out of order use or anomaly associated with the use of the set of resource distribution documents. As such, if one of these physical sensors is triggered, the system may identify and provide a silent alarm to the financial institution or teller that is presented with the resource distribution document.

Embodiments of the invention relate to systems, methods, and computer program products for physical marker coding of resource distribution documents, the invention comprising: identifying a set of resource distribution documents associated with a user; generating physical marker coding associated with the set of resource distribution documents associated with the user; capturing and storing geo-data and bio-data upon user generating and signing a resource distribution document from the set of resource distribution documents; identifying transfer of the generated and signed resource distribution document; capturing and storing geo-data and bio-data at the point of transfer of the resource distribution document; comparing the geo-data and bio-data from the generating and signing a resource distribution document to the geo-data and bio-data at the point of transfer of the resource distribution document; analyzing the physical marker coding associated with the resource distribution document and the comparison of the geo-data and bio-data; and triggering a silent alert based on the analysis indicating duress based on the physical marker coding being activated.

In some embodiments, the invention further comprises: identifying a transfer of the generated and signed resource distribution document from a first user to a second user; capturing and storing geo-data and bio-data from the first user and the second user at the transfer of the resource distribution document; validating the transfer based on a matching of the captured geo-data and bio-data from the first user during the transfer and the stored geo-data and bio-data from the first user generating and signing the resource distribution document from the set of resource distribution documents; identifying the second user depositing the resource distribution document; capturing and storing geo-data and bio-data from the second user depositing of the resource distribution document; and validating the depositing based on a matching of the captured geo-data and bio-data from the second user during the transfer and the stored geo-data and bio-data from the second user depositing of the resource distribution document, wherein the matching confirms the first user and the second user were not under duress during the transfer or the deposit.

In some embodiments, physical marker coding comprises a clip/crack mechanism that is activated by clipping or cracking a portion of the resource distribution document, wherein upon removing the resource distribution document from the set of resource distribution documents the physical marker coding is activated and transmitting geo-data and bio-data.

In some embodiments, comparing the geo-data and bio-data from the generating and signing a resource distribution document to the geo-data and bio-data at the point of transfer of the resource distribution document further comprises identifying differences in the geo-data and bio-data indicating duress including a difference in pressure drafting the resource distribution document or increase in heart rate of the user.

In some embodiments, capturing geo-data and bio-data upon user generating and signing the resource distribution document from the set of resource distribution documents further comprises activating the physical marker upon removal of the resource distribution document from the set of resource distribution documents and triggering the extraction of the geo-data and bio-data from one or more transmitting devices at the user location.

In some embodiments, geo-data comprises a location and a time associated with the user generating and signing a resource distribution document from the set of resource distribution documents or the user transferring the resource distribution document.

In some embodiments, bio-data comprises signature and writing pressure, signature style, heart rate of the user, finger pressure of the user, and fingers used by the user while the user generating and signing a resource distribution document from the set of resource distribution documents or while transferring the resource distribution document.

In some embodiments, resource distribution documents comprise one more checks from a set of checks associated with an account of the user for resource distribution.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, where:

FIG. 1 illustrates a physical marker code system environment, in accordance with embodiments of the present invention;

FIG. 2 is a flowchart illustrating marker code generation and deployment, in accordance with embodiments of the present invention;

FIG. 3 is a flowchart illustrating the use of marker coding on a physical document, in accordance with embodiments of the present invention;

FIG. 4 illustrates a representation of one embodiment of a resource distribution document, in accordance with embodiments of the present invention;

FIG. 5 illustrates a representation of one embodiment of a resource distribution document, in accordance with embodiments of the present invention;

FIG. 6 is a flowchart illustrating physical marker utilization on a resource distribution document, in accordance with embodiments of the present invention; and

FIG. 7 illustrates various marker coding generated by the system, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

A “transaction” or “resource distribution” refers to any communication between a user and the financial institution or other entity monitoring the user's activities to transfer funds for the purchasing or selling of a product. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

In some embodiments, a “marker code” as used herein may refer to one or more marks, signals, data points, or the like that may indicate a misappropriation. The marker code may include a multi-factor authentication via geo-data and bio-data or physical sensor. In this way, the system may include marker codes such as finger orientation, physical marker on a check hotspot, clip/crack location on check, other physical marker on a check, or bio-data such as pressure used to write the check, heart rate, location, time of day, signature style, check profile rules, or the like as marker codes for authentication of the resource distribution document.

In some embodiments, bio-data as disclosed herein includes data such as signature and writing pressure, time of day, signature style, heart rate, finger pressure, fingers used, other biometrics, and/or the like. In some embodiments, geo-data includes location data, time data, spatial data, and/or the like.

In some embodiments, a “resource distribution document” as used herein may refer to any paper or digital document that may transfer or exchange resources, such as funds, across individuals or entities. Resource distribution documents may include checks, certified checks, automated clearing house, contract, or the like.

In some embodiments, an “entity” may be a financial institution or third party merchant. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by the entity. In other embodiments, an entity may not be a financial institution. In still other embodiments, the entity may be the merchant itself. In some embodiments, the “user” may be a customer (e.g., an account holder).

Embodiments of the invention are directed to systems, methods and computer program products for providing physical marker coding for resource distribution adjustment or duress signaling when using paper resource distribution documents. Paper resource distribution documents have limited amount of multi-factor authentication. Thus, the system provides a system for multi-factor authentication of paper documents for enhancement of the authentication and security of utilizing paper resource distribution documents. Real-time and/or archived bio-data and geo-data are leveraged to validate the authentication of a resource distribution document. The data associated with the resource distribution document presented at a downstream point are used to verify the authentication of the drafting and executing of the resource distribution document.

Paper resource distribution documents have limited amount of multi-factor authentication. Thus, a need exists for a physical marker coding for resource distribution adjustment or duress signaling when using paper resource distribution documents. The invention provides multiple opportunities using the system networks described herein to enhance the authentication and security measures for multi-factor paper resource distribution document authentication.

Real-time and/or archived bio-data and geo-data are leveraged to validate the authentication of a resource distribution document presented for deposit. The data associated with the resource distribution document presented at a downstream transaction point can be used to verify that the user was not under duress when drafting and executing the resource distribution document.

The system may stop or flag resource distribution documents, such as checks, that are made under duress. In this way, the system may recognize forced payments and distinguish those from consent payments using multi-factor authentication via geo-data and bio-data. In this way, the system may identify finger orientation, physical marker on a check hotspot, clip/crack location on check, other physical marker on a check, or bio-data such as pressure used to write the check, heart rate, location, time of day, signature style, check profile rules, or the like as marker codes for authentication of the resource distribution document. The system may alert a financial institution or other recipient of the resource distribution document that the document was forced or misappropriated under duress via a silent alert system.

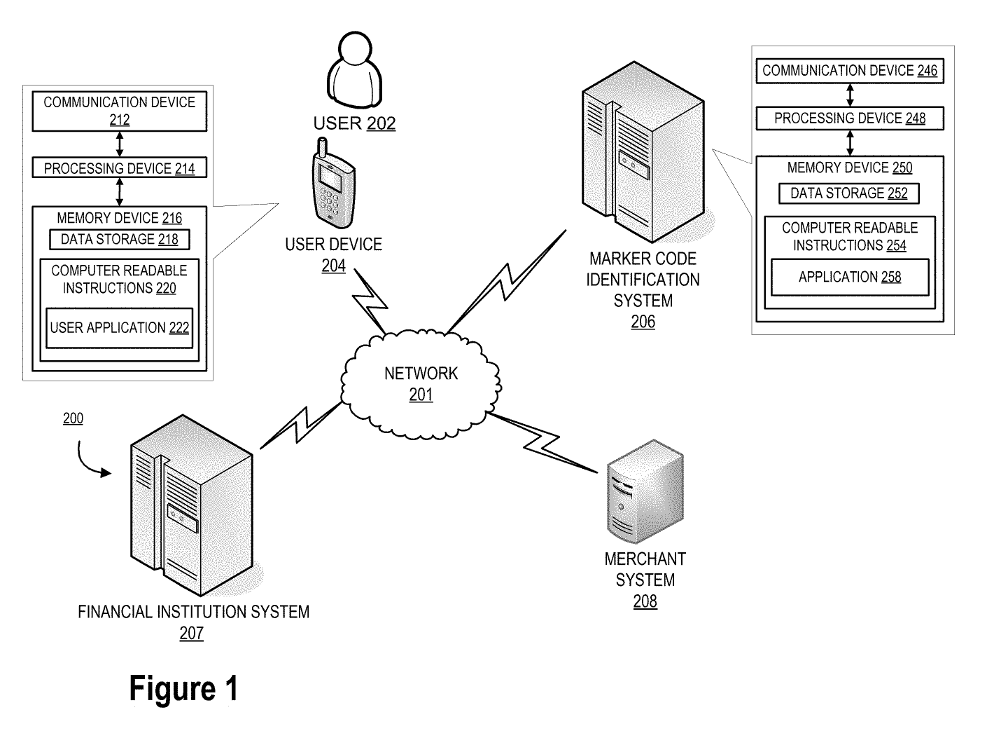

FIG. 1 illustrates a physical marker code system environment 200, in accordance with embodiments of the present invention. FIG. 1 provides the system environment 200 for which the distributive network system with specialized data feeds associated with resource distribution. FIG. 1 provides a unique system that includes specialized servers and system communicably linked across a distributive network of nodes required to perform the functions of physical maker coding for resource distribution adjustment and authentication.

As illustrated in FIG. 1, the merchant system 208 is operatively coupled, via a network 201 to the user device 204, financial institution system 207, and to the marker code identification system 206. In this way, the merchant system 208 can send information to and receive information from the user device 204, financial institution system 207, and the marker code identification system 206. FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is an individual that is making a transaction at a merchant system 208 and/or a financial institution system 207 using a resource distribution document. In some embodiments, the user 202 has a user device, such as a mobile phone, tablet, computer, or the like. FIG. 1 also illustrates a user device 204. The user device 204 may be, for example, a desktop personal computer, business computer, business system, business server, business network, a mobile system, such as a cellular phone, smart phone, personal data assistant (PDA), laptop, or the like. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the marker code identification system 206, the merchant system 208, and the financial institution system 207. As such, the communication device 212 generally comprises a modem, server, or other device for communicating with other devices on the network 201.

The user device 204 comprises computer-readable instructions 220 and data storage 218 stored in the memory device 216, which in one embodiment includes the computer-readable instructions 220 of a user application 222. In some embodiments, the user application 222 allows a user 202 to set up marker codes, send marker codes, and receive the necessary trigger responses.

As further illustrated in FIG. 1, the marker code identification system 206 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the merchant system 208, the financial institution system 207, and the user device 204. As such, the communication device 246 generally comprises a modem, server, or other device for communicating with other devices on the network 201.

As further illustrated in FIG. 1, the marker code identification system 206 comprises computer-readable instructions 254 stored in the memory device 250, which in one embodiment includes the computer-readable instructions 254 of an application 258. In some embodiments, the memory device 250 includes data storage 252 for storing data related to the system environment 200, but not limited to data created and/or used by the application 258.

In one embodiment of the marker code identification system 206 the memory device 250 stores an application 258. Furthermore, the marker code identification system 206, using the processing device 248 codes certain communication functions described herein. In one embodiment, the computer-executable program code of an application associated with the application 258 may also instruct the processing device 248 to perform certain logic, data processing, and data storing functions of the application. The processing device 248 is configured to use the communication device 246 to communicate with and ascertain data from one or more merchant system 208, financial institution system 207, and/or user device 204.

As illustrated in FIG. 1, the financial institution system 207 is connected to the merchant system 208, user device 204, and marker code identification system 206. The financial institution system 207 has the same or similar components as described above with respect to the user device 204 and the marker code identification system 206. While only one financial institution system 207 is illustrated in FIG. 1, it is understood that multiple financial institution system 207 may make up the system environment 200. The financial institution system 207 may be associated with one or more entities, such as resource providing machines, product providers, service providers, resource allocators, and the like. In this way, the financial institution system 207 may be associated with any third party merchant, financial institution, or the like that the user 202 may transact with.

As illustrated in FIG. 1, the merchant system 208 is connected to the financial institution system 207, user device 204, and marker code identification system 206. In other embodiments, the merchant system 208 may be a third party system separate from the marker code identification system 206. The merchant system 208 has the same or similar components as described above with respect to the user device 204 and the marker code identification system 206. While only one merchant system 208 is illustrated in FIG. 1, it is understood that multiple merchant system 208 may make up the system environment 200.

It is understood that the servers, systems, and devices described herein illustrate one embodiment of the invention. It is further understood that one or more of the servers, systems, and devices can be combined in other embodiments and still function in the same or similar way as the embodiments described herein. The merchant system 208 may generally include a processing device communicably coupled to devices as a memory device, output devices, input devices, a network interface, a power source, one or more chips, and the like. The merchant system 208 may also include a memory device operatively coupled to the processing device. As used herein, memory may include any computer readable medium configured to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like.

The memory device may store any of a number of applications or programs which comprise computer-executable instructions/code executed by the processing device to implement the functions of the merchant system 208 described herein.

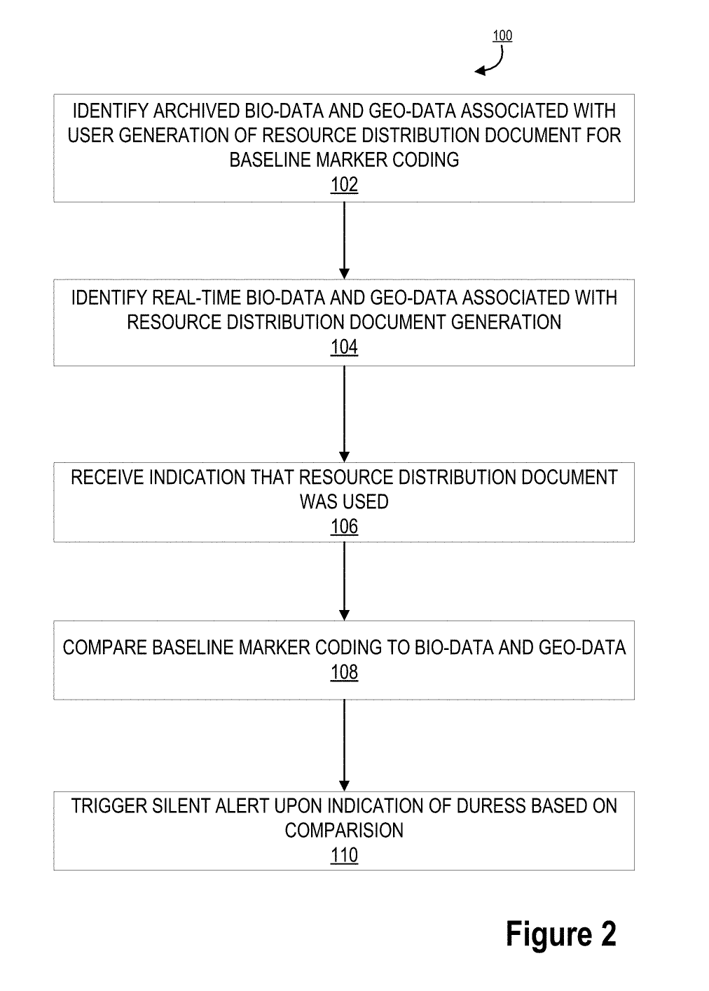

FIG. 2 illustrates marker code generation and deployment 100, in accordance with embodiments of the present invention. As illustrated, the process 100 is initiated by identifying archived bio-data and geo-data associated with user generation of resource distribution documents for a baseline user marker, as illustrated in block 102. In this way, the system identifies bio-data from archived resource distribution documents. This bio-data may include the signature style of the user, the signature pressure of the user, the hand the user uses to sign, the orientation of the user hand when signing, biometric data or the like. The geo-data may include a location of signing the resource distribution document, a trend in time of day associated with signing the resource distribution documents, or the like. The bio-data and geo-data may be identified using user associated internet-of-things devices, user associated mobile devices, user associated GPS devices, user associated wireless internet systems, cameras, or the like.

Next, as illustrated in block 104, the process 100 continues by identifying real-time bio-data and geo-data associated with a resource distribution document generation by a user. In this way, the system may identify that a user is generating a new resource distribution document. In real-time, the system may identify the bio-data and geo-data associated with the drafting of the resource distribution document that the user is drafting. In this way, the system may identify the signature style of the user, the signature pressure of the user, the hand the user uses to sign, the orientation of the user hand when signing, biometric data or the like. Furthermore, the system may identify the geo-data, such as the location of signing the resource distribution document, a trend in time of day associated with signing the resource distribution documents, or the like. The bio-data and geo-data may be identified using user associated internet-of-things devices, user associated mobile devices, user associated GPS devices, user associated wireless internet systems, cameras, or the like.

Next, as illustrated in block 106, the process 100 continues by receiving an indication that the resource distribution document was used during a transaction. This may include a check deposit, check cashing, contract completion, or the like. In this way, the system may receive the indication from a third party, a financial institution, or the like. The system may receive an indication via a secure communication channel that a resource distribution document has been used to complete a financial transaction.

As illustrated in block 108, the process 100 continues by comparing the baseline marker coding to the bio-data and geo-data from the real-time bio-data and geo-data associated with the resource distribution document created. In this way, the archived data from block 102 is compared to the real-time data from the resource distribution document generation to compare the differences to determine if a difference is illustrated to a level of duress or misappropriation.

Next, as illustrated in block 110, the process 100 ends by triggering a silent alert upon an indication of the duress or misappropriation based on the comparison. In this way, upon system determination that the archived and real-time bio-data and geo-data comparison indication that there may be misappropriation and/or duress, the system may trigger a silent alert to the financial institution teller, the authorities such as police or the like, and the like to identify misappropriation and/or duress by the user using the resource distribution document.

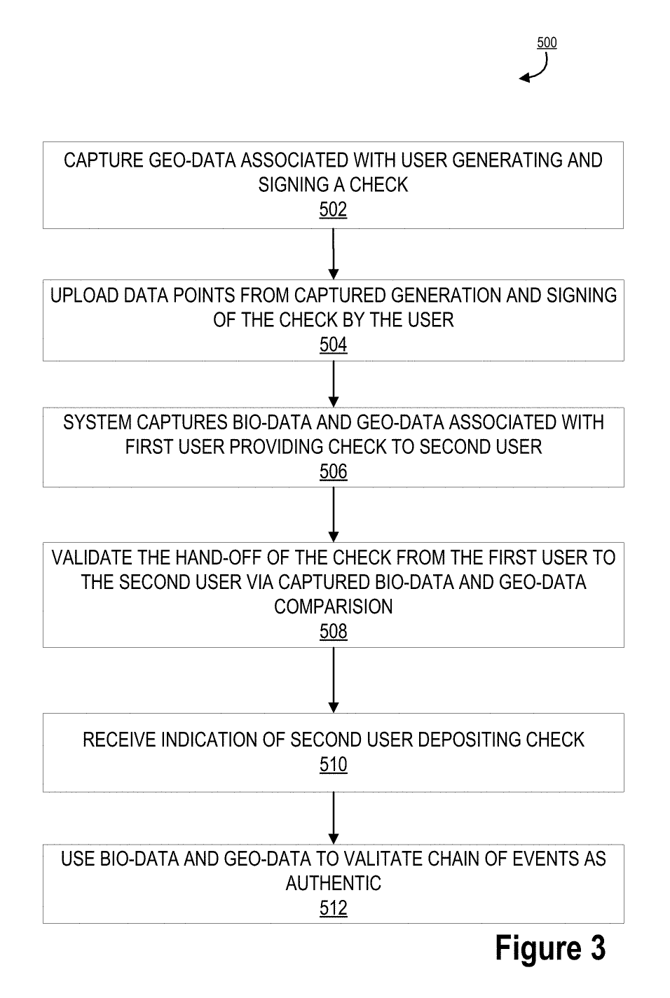

FIG. 3 illustrates the use of marker coding on a physical document 500, in accordance with embodiments of the present invention. As illustrated in block 502, the process 500 is initiated by capturing geo-data associated with the user generating and signing a resource distribution document, such as a check. The geo-data from the first user's internet-of-things devices, beacons, wireless internet, or the like is captured and now associated with that check at that point of time. The data is uploaded at various data points during the drafting of the check, thus creating a natural data capture that does not involve additional components to the actual check. The geo-data may include the location of signing the resource distribution document, a trend in time of day associated with signing the resource distribution documents, or the like.

As illustrated in block 504, the process 500 continues by uploading data points from the captured generation and signing of the check by the user. In this way, the system identifies the geo-data and bio-data of the user during the generation and signing of the resource distribution document associate with the user.

Next, the first user may hand-off the check to a second user. As illustrated in block 506, the process continues by capturing the bio-data and geo-data during the hand-off between the first you and the second user. As such, the system captures bio-data and geo-data associated with the hand-off, which may include the location, time of day, heart rate, finger pressure, fingers used, other biometrics, time data, spatial data, and/or the like associated with the hand-off.

At this point, the system validates the hand-off of the check from the first user to the second user via the captured bio-data and geo-data, as illustrated in block 508. In this way, the system reviews the captured bio-data and geo-data to identify if the hand-off was a consented hand-off from the first user to the second user or if there was an indicator of duress and/or force during the hand-off. As such, the data is used to validate that the first user did indeed willingly pass the check to the second user.

Next, as illustrated in block 510, the process 500 continues by receiving an indication that the second user is depositing the check. In some embodiments, the indication may be received directly from the teller at a financial institution branch via communication linkage with the teller device. In other embodiments, the system may identify the second user via security cameras, geo-data, bio-data, or the like when the second user transacts with the financial institution to complete the transaction. Finally, as illustrated in block 512, the process 500 is finalized upon system utilization and monitoring of the bio-data and geo-data collected from the first user generating the check, the hand-off between the first user and the second user, and the second user depositing the check. At each point, the system monitors the user's bio-data and geo-data to identify anomalies in the data that may indicate duress from the user during the process. In this way, all of the previous bio-data and geo-data may be combined in order to authentication and validate the check for processing.

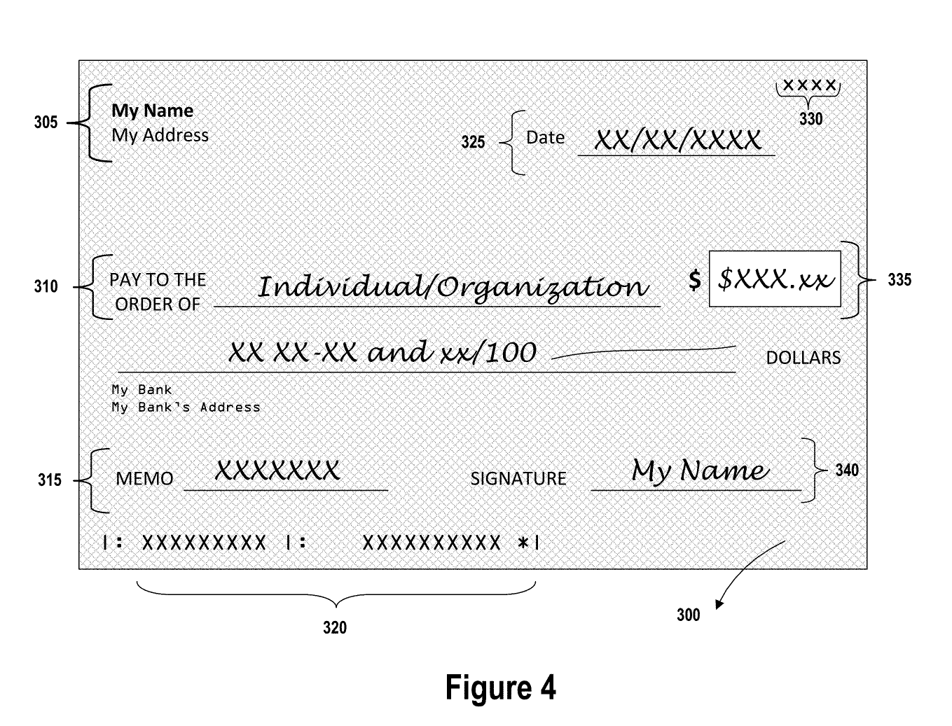

FIG. 4 illustrates a representation of one embodiment of a resource distribution document 300, in accordance with embodiments of the present invention. The financial record illustrated in FIG. 4 is a check. However, one will appreciate that any financial record, financial document, or the like may be provided.

The image of check 300 may comprise an image of the entire check, a thumbnail version of the image of the check, individual pieces of check information, all or some portion of the front of the check, all or some portion of the back of the check, or the like. Check 300 comprises check information, wherein the check information comprises contact information 305, the payee 310, the memo description 315, the account number and routing number 320 associated with the appropriate user or customer account, the date 325, the check number 330, the amount of the check 335, the signature 340, or the like. In some embodiments, the check information may comprise text. In other embodiments, the check information may comprise an image. A capture device may capture an image of the check 300 and transmit the image to a system of a financial institution via a network. The system may collect the check information from the check 300 and store the check information in a datastore as metadata. In some embodiments, the pieces of check information may be stored in the datastore individually. In other embodiments, multiple pieces of check information may be stored in the datastore together.

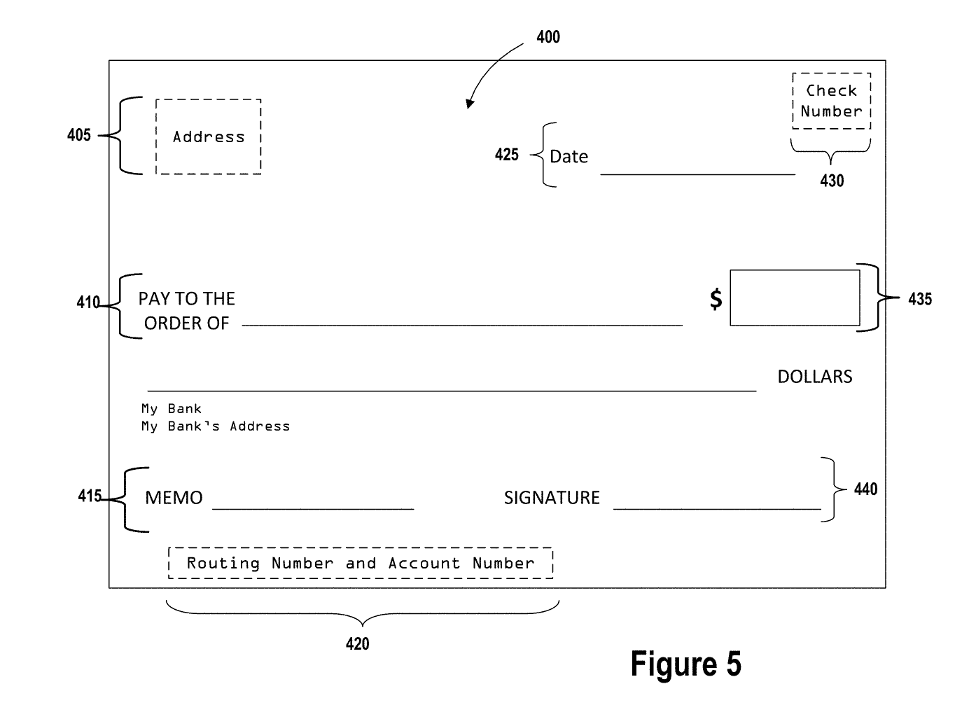

FIG. 5 illustrates a representation of one embodiment of a resource distribution document 400, in accordance with embodiments of the present invention. Again, the resource distribution document illustrated in FIG. 5 is a check. However, one will appreciate that any financial record, financial document, or the like may be provided.

In the illustrated embodiment, the check corresponds to the entire front portion of a check, but it will be understood that the check may also correspond to individual pieces of check information, portions of a check, or the like. The check, in some embodiments, includes the format of certain types of checks associated with a bank, a merchant, an account holder, types of checks, style of checks, check manufacturer, and so forth. By using the check template, the system of process any other system can “learn” to map the key attributes of the check for faster and more accurate processing. Furthermore, the system may map key marker code locations on a physical check, such as a physical marker on a check hotspot, clip/crack location on check, other physical marker on a check.

The check comprises check information, wherein the check information includes, for example, a contact information field 405, a payee line field 410, a memo description field 415, an account number and routing number field 420 associated with the appropriate user or customer account, a date line field 425, a check number field 430, an amount box field 435, a signature line field 440, or the like.

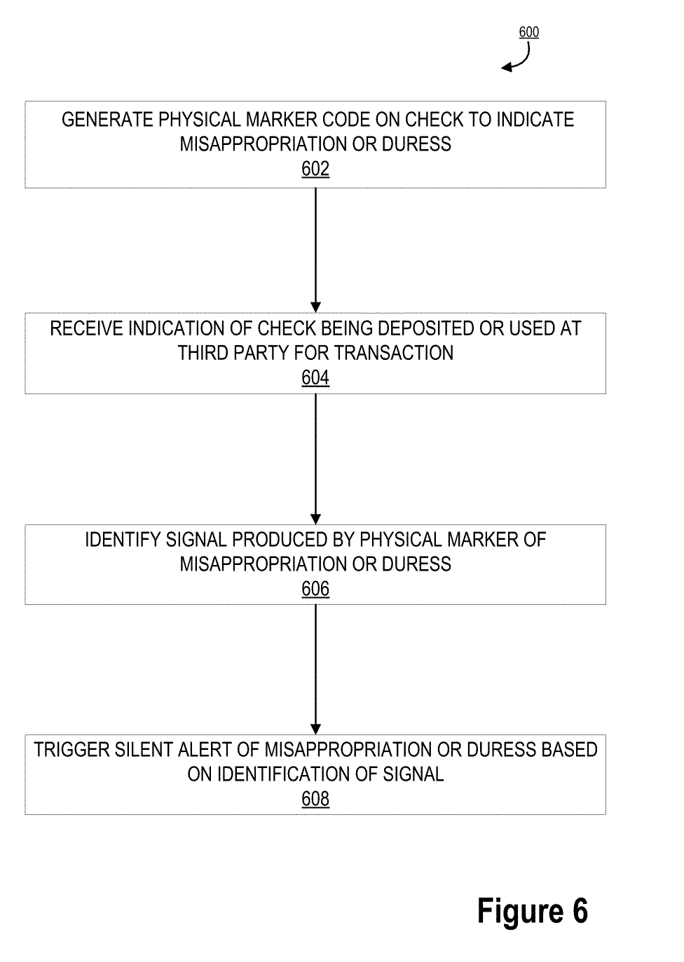

FIG. 6 is a flowchart illustrating physical marker utilization on a resource distribution document 600, in accordance with embodiments of the present invention. The process 600 is initiated in block 602 by generating a physical marker code on a resource distribution document, such as a check, to indicate misappropriation or duress. The physical marker code may include a location on the check that may be marked by the user to indicate duress, a clip/crack location on the check that may be broken or clipped by the user to indicate duress, a specific code or signature that is different from the user's normal signature that indicates duress, or the like.

Once the physical marker is generated and/or identified for that user and stored within the system, the process 600 continues by receiving an indication that the check is being deposited or being used at a third party for a transaction, as illustrated in block 604. This indication may be communicated by the merchant, teller, financial institution system, or the like. In other embodiments, the system may track and identify the depositing or use at a third party based on bio-data and/or geo-data associated with the user or the physical marker. In this way, in some embodiments, the physical marker may include a beacon or other communication device to communicate with the system the location of the check at any time. Furthermore, the physical marker may be able to communicate upon being removed from a checkbook. In this way, upon user removing the check from his/her checkbook, the physical marker may be activated and transmitting.

Next, as illustrated in block 606, the process 600 continues by identifying the signal produced by the physical marker indicating misappropriation or duress of the user. The signal may be a mark or notation on the check, a transmitted wireless signal, or the like. In this way, the system may identify the signal being presented based on the check. In some embodiments, the system is communicated the signal via a secure communication linkage from the physical marker directly. In some embodiments, the system may receive the signal from a third party such as a teller, financial institution system, third party system or the like. Once the signal has been identified by the system, the system triggers a silent alert of the misappropriation or duress based on the identification of the signal, as illustrated in block 608. In this way, the system may communicate with the financial institution or third party merchant at the point of transaction to communicate the alert of potential duress. In other embodiments, the system may communicate directly to the authorities about the user duress.

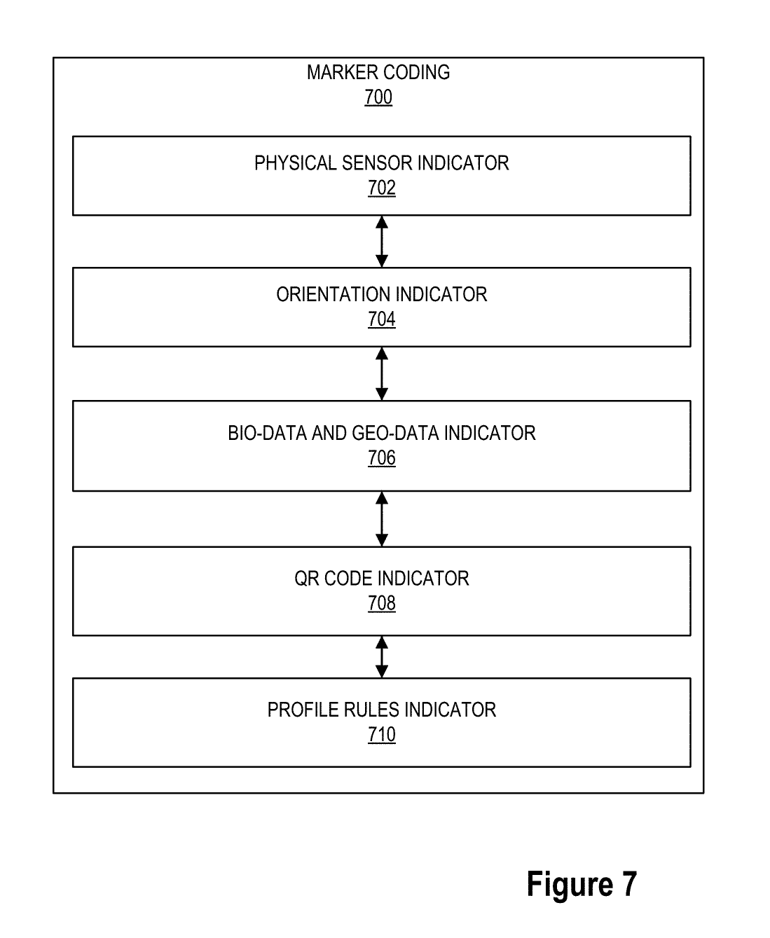

FIG. 7 illustrates various marker coding generated by the system 700, in accordance with embodiments of the present invention. As illustrated the marker coding 700 may include a physical sensor indicator 702, an orientation indicator 704, a bio-data and geo-data indicator 706, a QR code indicator 708, and/or a profile rules indicator 710.

As illustrated, one of the marker coding 700 may include a physical sensor indicator 702. Physical sensors indicators may hot spot locations where if marked by the user indicates duress, a clip/crack location where if broken or clipped indicates duress, and/or a physical marker associated with a group of resource distribution documents that indicate an out of order use or anomaly associated with the use of the set of resource distribution documents. As such, if one of these physical sensors is triggered, the system may identify and provide a silent alarm to the financial institution or teller that is presented with the resource distribution document. Thus providing a stop payment to the resource distribution document.

As illustrated, one of the marker coding 700 may include an orientation indicator 704. In this way, in some embodiments a user may select to deposit a check using a camera on a mobile device associated with the user. The user may be able to orientate the camera a specific direction relative to the check in order to indicate a duress. The system may then track the location of the user via the mobile device GPS system. Furthermore, the system may provide a stop payment for the check. As such, if one of these orientation indicators is triggered the system may identify and provide a silent alarm to the financial institution or teller that is presented with the resource distribution document. Thus providing a stop payment to the resource distribution document.

As illustrated, one of the marker coding 700 may include a bio-data and geo-data indicator 706. The bio-data may include data such as signature and writing pressure, time of day, signature style, heart rate, finger pressure, fingers used, other biometrics, and/or the like. In some embodiments, geo-data includes location data, time data, spatial data, and/or the like. As such, if one of these is triggered, the system may identify and provide a silent alarm to the financial institution or teller that is presented with the resource distribution document. In some embodiments, the bio-data and geo-data may be associated together to identify the triggering of duress. Thus providing a stop payment to the resource distribution document.

As illustrated, one of the marker coding 700 may include a QR code indicator 708. In this way, the resource distribution document may comprise a printed QR code on the face of the resource distribution document. The QR code may be activated upon removal of the resource distribution document from a set of resource distribution documents. Upon activation, the system may track the QR code and its location. Furthermore, the user may be able to mark on the QR code to indicate a duress situation. As such, if one of the QR code is marked, the system may identify and provide a silent alarm to the financial institution or teller that is presented with the resource distribution document. Thus providing a stop payment to the resource distribution document.

As illustrated, one of the marker coding 700 may include a profile rules indicator 710. The profile rules indicators include rules for the resource distribution documents, such as identification of the resource distribution documents being out of sequence, inactive for a period of time, out of state usage, an amount tolerance level, or out of normal behavior for the user's use of the resource distribution documents. As such, if these rules are triggered, the system may identify and provide a silent alarm to the financial institution or teller that is presented with the resource distribution document. Thus providing a stop payment to the resource distribution document.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for physical marker coding of resource distribution documents, the system comprising:
a memory device with computer-readable program code stored thereon;
a communication device;
a processing device operatively coupled to the memory device and the communication device, wherein the processing device is configured to execute the computer-readable program code to:
identify a set of resource distribution documents associated with a user;
generate physical marker coding associated with the set of resource distribution documents associated with the user;
capture and store geo-data and bio-data upon user generating and signing a resource distribution document from the set of resource distribution documents;
identify transfer of the generated and signed resource distribution document;
capture and store geo-data and bio-data at the point of transfer of the resource distribution document;
compare the geo-data and bio-data from the generating and signing a resource distribution document to the geo-data and bio-data at the point of transfer of the resource distribution document;
analyze the physical marker coding associated with the resource distribution document and the comparison of the geo-data and bio-data; and
trigger a silent alert based on the analysis indicating duress based on the physical marker coding being activated.

2. The system of claim 1, further comprising:
identifying a transfer of the generated and signed resource distribution document from a first user to a second user;
capturing and storing geo-data and bio-data from the first user and the second user at the transfer of the resource distribution document;
validating the transfer based on a matching of the captured geo-data and bio-data from the first user during the transfer and the stored geo-data and bio-data from the first user generating and signing the resource distribution document from the set of resource distribution documents;
identifying the second user depositing the resource distribution document;
capturing and storing geo-data and bio-data from the second user depositing of the resource distribution document; and
validating the depositing based on a matching of the captured geo-data and bio-data from the second user during the transfer and the stored geo-data and bio-data from the second user depositing of the resource distribution document, wherein the matching confirms the first user and the second user were not under duress during the transfer or the deposit.

3. The system of claim 1, wherein physical marker coding comprises a clip/crack mechanism that is activated by clipping or cracking a portion of the resource distribution document, wherein upon removing the resource distribution document from the set of resource distribution documents the physical marker coding is activated and transmitting geo-data and bio-data.

4. The system of claim 1, wherein comparing the geo-data and bio-data from the generating and signing a resource distribution document to the geo-data and bio-data at the point of transfer of the resource distribution document further comprises identifying differences in the geo-data and bio-data indicating duress including a difference in pressure drafting the resource distribution document or increase in heart rate of the user.

5. The system of claim 1, wherein capturing geo-data and bio-data upon user generating and signing the resource distribution document from the set of resource distribution documents further comprises activating the physical marker upon removal of the resource distribution document from the set of resource distribution documents and triggering the extraction of the geo-data and bio-data from one or more transmitting devices at the user location.

6. The system of claim 1, wherein geo-data comprises a location and a time associated with the user generating and signing a resource distribution document from the set of resource distribution documents or the user transferring the resource distribution document.

7. The system of claim 1, wherein bio-data comprises signature and writing pressure, signature style, heart rate of the user, finger pressure of the user, and fingers used by the user while the user generating and signing a resource distribution document from the set of resource distribution documents or while transferring the resource distribution document.

8. The system of claim 1, wherein resource distribution documents comprise one more checks from a set of checks associated with an account of the user for resource distribution.

9. A computer program product for physical marker coding of resource distribution documents, the computer program product comprising at least one non-transitory computer-readable medium having computer-readable program code portions embodied therein, the computer-readable program code portions comprising:
an executable portion configured for identifying a set of resource distribution documents associated with a user;
an executable portion configured for generating physical marker coding associated with the set of resource distribution documents associated with the user;
an executable portion configured for capturing and storing geo-data and bio-data upon user generating and signing a resource distribution document from the set of resource distribution documents;
an executable portion configured for identifying transfer of the generated and signed resource distribution document;
an executable portion configured for capturing and storing geo-data and bio-data at the point of transfer of the resource distribution document;
an executable portion configured for comparing the geo-data and bio-data from the generating and signing a resource distribution document to the geo-data and bio-data at the point of transfer of the resource distribution document;
an executable portion configured for analyzing the physical marker coding associated with the resource distribution document and the comparison of the geo-data and bio-data; and
an executable portion configured for triggering a silent alert based on the analysis indicating duress based on the physical marker coding being activated.

10. The computer program product of claim 9, further comprising:
an executable portion configured for identifying a transfer of the generated and signed resource distribution document from a first user to a second user;
an executable portion configured for capturing and storing geo-data and bio-data from the first user and the second user at the transfer of the resource distribution document;
an executable portion configured for validating the transfer based on a matching of the captured geo-data and bio-data from the first user during the transfer and the stored geo-data and bio-data from the first user generating and signing the resource distribution document from the set of resource distribution documents;
an executable portion configured for identifying the second user depositing the resource distribution document;
an executable portion configured for capturing and storing geo-data and bio-data from the second user depositing of the resource distribution document; and
an executable portion configured for validating the depositing based on a matching of the captured geo-data and bio-data from the second user during the transfer and the stored geo-data and bio-data from the second user depositing of the resource distribution document, wherein the matching confirms the first user and the second user were not under duress during the transfer or the deposit.

11. The computer program product of claim 9, wherein physical marker coding comprises a clip/crack mechanism that is activated by clipping or cracking a portion of the resource distribution document, wherein upon removing the resource distribution document from the set of resource distribution documents the physical marker coding is activated and transmitting geo-data and bio-data.

12. The computer program product of claim 9, wherein comparing the geo-data and bio-data from the generating and signing a resource distribution document to the geo-data and bio-data at the point of transfer of the resource distribution document further comprises identifying differences in the geo-data and bio-data indicating duress including a difference in pressure drafting the resource distribution document or increase in heart rate of the user.

13. The computer program product of claim 9, wherein capturing geo-data and bio-data upon user generating and signing the resource distribution document from the set of resource distribution documents further comprises activating the physical marker upon removal of the resource distribution document from the set of resource distribution documents and triggering the extraction of the geo-data and bio-data from one or more transmitting devices at the user location.

14. The computer program product of claim 9, wherein geo-data comprises a location and a time associated with the user generating and signing a resource distribution document from the set of resource distribution documents or the user transferring the resource distribution document.

15. The computer program product of claim 9, wherein bio-data comprises signature and writing pressure, signature style, heart rate of the user, finger pressure of the user, and fingers used by the user while the user generating and signing a resource distribution document from the set of resource distribution documents or while transferring the resource distribution document.

16. The computer program product of claim 9, wherein resource distribution documents comprise one more checks from a set of checks associated with an account of the user for resource distribution.

17. A computer-implemented method for physical marker coding of resource distribution documents, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
identifying a set of resource distribution documents associated with a user;
generating physical marker coding associated with the set of resource distribution documents associated with the user;
capturing and storing geo-data and bio-data upon user generating and signing a resource distribution document from the set of resource distribution documents;
identifying transfer of the generated and signed resource distribution document;
capturing and storing geo-data and bio-data at the point of transfer of the resource distribution document;
comparing the geo-data and bio-data from the generating and signing a resource distribution document to the geo-data and bio-data at the point of transfer of the resource distribution document;
analyzing the physical marker coding associated with the resource distribution document and the comparison of the geo-data and bio-data; and
triggering a silent alert based on the analysis indicating duress based on the physical marker coding being activated.

18. The computer-implemented method of claim 17, further comprising:
identifying a transfer of the generated and signed resource distribution document from a first user to a second user;
capturing and storing geo-data and bio-data from the first user and the second user at the transfer of the resource distribution document;
validating the transfer based on a matching of the captured geo-data and bio-data from the first user during the transfer and the stored geo-data and bio-data from the first user generating and signing the resource distribution document from the set of resource distribution documents;
identifying the second user depositing the resource distribution document;
capturing and storing geo-data and bio-data from the second user depositing of the resource distribution document; and
validating the depositing based on a matching of the captured geo-data and bio-data from the second user during the transfer and the stored geo-data and bio-data from the second user depositing of the resource distribution document, wherein the matching confirms the first user and the second user were not under duress during the transfer or the deposit.

19. The computer-implemented method of claim 17, wherein physical marker coding comprises a clip/crack mechanism that is activated by clipping or cracking a portion of the resource distribution document, wherein upon removing the resource distribution document from the set of resource distribution documents the physical marker coding is activated and transmitting geo-data and bio-data.

20. The computer-implemented method of claim 17, wherein geo-data comprises a location and a time associated with the user generating and signing a resource distribution document from the set of resource distribution documents or the user transferring the resource distribution document, wherein bio-data comprises signature and writing pressure, signature style, heart rate of the user, finger pressure of the user, and fingers used by the user while the user generating and signing a resource distribution document from the set of resource distribution documents or while transferring the resource distribution document.
